(19) United States
(12) Patent Application Publication
(10) Pub. No.: US 2019/0065029 A1
(43) Pub. Date: Feb. 28, 2019

(54) System and Method of Graphical Metadata Assignation and Filtering by Deriving Hierarchical Icon-Based Signifiers from a Multi-Channel Database Assemblage

(71) Applicant: Daniel Brody, New Milford, NJ (US)

(72) Inventor: Daniel Brody, New Milford, NJ (US)

(21) Appl. No.: 15/794,726

(22) Filed: Oct. 26, 2017

Related U.S. Application Data
(60) Provisional application No. 62/550,074, filed on Aug. 25, 2017.

(51) Int. Cl. G06F 3/0481; G06F 3/0482; H04L 12/58

(52) U.S. Cl. CPC G06F 3/04817; H04L 51/32; G06F 3/0482

(57) ABSTRACT

A method and system of assembling, framing, searching, and filtering icon-based communications operating over a network of users organized into groups, with icon-based databases relating in hierarchies established by user groups and icons associated with communications as metadata.

### PRIORITY CLAIM

This application incorporates in full U.S. provisional application No. 62/550,074, filed on Aug. 25, 2017 and claims priority to the same.

### BACKGROUND

Mobile devices loaded with email, messaging, and social networking platforms have both increased the ease, frequency, and significance of virtual communications. As more of everyday life, including matters public and personal, consequential and trivial, resides in, or is initiated or actuated by, electronic communications, it has become increasingly difficult to sort and organize and prioritize tasks and activities. Part of the reason for this is because a single person may, at any particular moment, regardless of location, find him or herself barraged by an influx of news, invitations to social events, work-related requests or instructions, or entertainment options. It has become common, perhaps even nearly universal, for professionals to carry two or more mobile devices—the first for social use, the second for work, and the third for entertainment, such as a tablet. It is clear that society has a need for and a difficulty in compartamentalizing life's many responsibilities and outlets. The technical problem lies in a lack of mechanisms to frame, filter, and search the data that comprises our communications and related information. Even if a local system can adequately manage the information, that information is not valuable unless it can be shared across a network used by individuals with different preferences and device behavior. The present application seeks to resolve these tension by providing a method to allocate data using a modular, group-based identification and hierarchical storage and retrieval system accessible over a network.

### SUMMARY

The icon-based framing, searching, and filtering method and system features, in one aspect, a database of icons. Each icon is a graphical image or set of images designed to represent an idea, user, location, or any other appropriate subject or category. Essentially, these icons say something that informs users as to the significance and meaning of a given message or communication to which the icons may be tagged. In this sense, the icons serve as a frame or context for the communication. Thus, communications in the system may comprise both an icon portion and a text portion. Importantly, the icons also provide functionality by allowing users to filter communications. In a variation of the system, the text portion of a communication may also be filtered by a keyword search that is either separate from or in addition to an icon search entry field.

Icons may be organized hierarchically in a system database so that one icon may categorically embody one or more other icons. This hierarchical relationship may be pre-defined by the system, or defined or modified by a user or community of users. The database may track changes and the hierarchical relationships and associate those changes with the relevant user or community. Relatedly, the database may be pre-loaded with icons or uploaded or modified by a user or community of users. For example, a user may select or upload an icon and establish in the database that the icon represents himself, as a user, in the user's navigation and use of the messaging system, including his interactions as a sender or recipient of messages to and from other users. As another example, a user or set of users may establish in the database that an icon represents a community which other users may join, or a set of users selected by the user or set of users.

Users may establish the icon-based hierarchical relationships through a user interface provided and displayed by the system. Work may be done within the system or uploaded into the system via a spreadsheet or any other organizational document. Communities may validate a set of changes or selections through an agreement determined by the system and arrived at via indications sent by members of the community to the system via a user interface. Alternately, the community may recognize, virtually, a manager or set of managers who may then unilaterally make such changes or selections.

The system may pre-define a list of unique icons or icon categories which will be treated differently than other icons, which may otherwise be organized or defined according to some consistent default set of rules. These unique icons may follow one or more other sets of rules which are applied as a group or in singular to those icons. Examples of these unique icon categories include geographical or linguistic subjects, and will be discussed later in this application. The system may provide several pre-existing hierarchies and rules which users or groups may select to self-apply.

There are many rules that may be applied by the system, either under the direction of users or automatically, by default, and inherently. One example is exclusive linkage, which may be applied to two or more separate icons whereby those two or more icons may be linked exclusively such that they categorically relate to and form a single unified icon. Both icons must be invoked in order to trigger the single unified icon. This invocation may occur either during the communication creation stage or the filtering stage, both of which are discussed below. Another example is partial exclusive linkage, in which two or more separate icons are linked such that they form a single unified icon, but unlike exclusive linkage, this icon may be triggered so long as some number, defined by the system or a user, of icons are invoked. If seven icons are partially exclusively linked, then if four, or five, or six icons are invoked, the others are “dragged” in the process as if they were all invoked. In one embodiment, the aggregate unified icons may each be associated with their own unique icons and may be triggered if that unique icon is invoked even if the linked icons are not.

The exclusive linkage aspect may also be determined by a user during the filtering stage, to be further discussed. The user may identify what ratio or percentage of the icons entered into the filtered field must be encompassed by a unified icon. If that ratio is met, then the communication associated with the unified icon is displayed—otherwise, it is not. In a variation, communications that are associated with icons matching the icons entered in the filter field are displayed above those communications that are not associated with such icons or associated with fewer matching icons. In another variation, communications that are associated with icons not matching those entered in the filter stage or either not displayed or displayed less, even if all of the icons entered in the filter field are associated with the communication. This is to prevent people from over-tagging communications in order to sabotage the system.

The system may determine linkage of icons based on the content or other aspect of a communication. For example, if communications about a given news topic are predominantly sent or received by users operating in a given local location, then the system may link an icon representing that location to a news icons tagged to the communication, thus establishing in the system and consequentially limiting the scope of that news subject communication from other users who are searching for news communications of a more national or even global character. Similarly, the system may link a particular community icon to the the news icon tagged to a given news topic if the senders or recipients predominantly belong to a particular community, as determined by a self-identification made by user in their user profile or by the tagging of the particular community's icon in communications discussing the news topic.

In one embodiment, the messaging system may be configured to transfer communications from one individual user to another individual user via a private chat. In another embodiment, the messaging system may transfer communications amongst a set of individuals in group chat. In yet another embodiment, the messaging system may post communications in a blog, each communication as an individual post, or on a virtual bulletin board. In any of these embodiments, the communication may be a discrete message that appears separate from other communications in the user interface. Accordingly, the messaging system may feature a messaging creation interface designed to create a discrete communication and/or may attach to conventional live chat interfaces.

Communications, displayed by the system in a display step, may be displayed in a list or any other format. In one embodiment, the system displays abbreviated or representative forms of communications in a first step, and may display a given communication in its full form upon being selected by the user. The abbreviated form of a communication may display icons but not text, or icons and a small portion of text, whereas the full form will display at least all of the text.

The messaging creation interface may feature one or more sets of icons that may be selected by a user. The messaging creation interface may also feature a caption or text field configured to receive text submissions by the user. The system will link the icons selected to the text such that they appear wherever the message is displayed, although in one embodiment the icons are invisibly linked and not displayed when the message is displayed.

One set of icons displayed by the system includes the groups to which the user wishes to communicate the message. One or more group icons may be selected by a mouse, touch screen selection, or any other selection means. Another set of icons displayed by the system includes broad subject category icons. These icons may be conventionally selected, such as by a left mouse click, in which case they are attached to the user's text, or they may be alternately selected, such as by a right mouse click or a sustained mouse click, in which case the system will display a set of icons that hierarchically relate to the alternately selected icon in an ancestor/descendent relationship. Each of these icons may likewise be conventionally or alternately selected, each resulting in the actions taken by the system as described above. The set of icons displayed may be scrollable such that a partial set of the full set is displayed at any given time but may be rotated, moved, or scrolled through so that another partial set of the full set is displayed.

The message creation interface may display a location determined by the user's device. This location may be automatically determined and validated or removed by the user, or it may be generated manually by the user. Share options for various social networking platforms may be displayed; upon their selection by the user, the communication content may be transmitted via the relevant API to post thereon.

The system may provide a user interface for sharing communications made by other users, either by posting those communications on a social networking platform via the API, or by forwarding the communication to other users in the messaging system. This latter type of sharing may be amended by the forwarding user by the additional tagging of icons or additional icons. In this manner, the subject being communicated may be framed and reframed several times in order to help users of the messaging system ascertain the important aspects or value of the communication. The additional icons may be displayed in the same location as the original icons or in a separate area.

A messaging user may upload or select an icon to represent the user in communications. This icon may be displayed adjacent to any message sent by the user. Adjacent to the icon, the system may display the user's name or alias, as provided by the user during a profile or account creation step.

Communications may be filtered by means of icons selected by a user via a search or filter interface. The filter interface may display a set of icons. This set may be scrollable such that a partial set is displayed at any given moment, as described previously. When the user selects a given icon, communications are filtered according to whether or not they are tagged with that icon—that is, communications tagged with the selected icon are displayed and those that are not so tagged are not displayed. Users may select more than one icon, either simultaneously to the selection of the first icon or sequentially, thereby iterating the search results. Relatedly, users can deselect an icon, thus incorporating additional search results in the display. This may also be actuated iteratively. In one variation, users may enter keywords to filter. Icons associated with the keywords will be displayed, and these icons may be similarly selected by the user to be used by the system in icon filtering.

Examples of icon categories include events, including concerts, rallies, meetings, and celebrations, questions (posts in which one user “asks” other users), news, including global, national, and local, culture, including cuisine, music, film, art, and language, activities, including physical exercise, sports, hanging out, and religion.

Icon framing can be used to increase the communication value of a given icon. Framing affects the color, shape, hue, saturation, and borders of an icon. Each frame may indicate additional information about an icon, and frames can be combined. A first border frame may indicate that a given icon is designated as a group icon, whereas a second border frame, or lack thereof, may indicate that the icon is designated as an interest. This can help distinguish between people who are part of a community and those who are merely interested in some aspect of it. Saturation may indicate that a given icon, or communication or activity related to it, is active and desaturation may indicate that it is inactive.

### BRIEF DESCRIPTION OF THE DRAWINGS

FIG. 1 is a flow chart featuring an exemplary system architecture.

FIG. 2 is a flowchart featuring an exemplary text association process.

FIG. 3a is a flowchart featuring an exemplary search process.

FIG. 3b is a flowchart featuring an exemplary icon association process.

FIG. 4 is a flowchart featuring an exemplary icon association process.

FIG. 5 is a flowchart featuring an exemplary user icon identification process.

FIG. 6 is a flowchart featuring an exemplary user icon identification process.

FIG. 7 is a flowchart featuring an exemplary group icon identification process.

FIG. 8 is a flowchart featuring an exemplary group icon identification process.

FIG. 9 is a flowchart featuring an exemplary user-user communication process.

FIG. 10 is a flowchart featuring an exemplary group communication process.

FIG. 11 is a flowchart featuring an exemplary communication process.

FIG. 12 is a flowchart featuring an exemplary group hierarchy control process.

FIG. 13 is a flowchart featuring an exemplary group hierarchy control process.

FIG. 14 is a flowchart featuring an exemplary icon filtering process.

FIG. 15 is a flowchart featuring an exemplary icon-based communication filtering process.

FIG. 16 is a flowchart featuring an exemplary icon-based communication filtering process.

FIG. 17 is a flowchart featuring an exemplary icon hierarchy-based communication filtering process.

FIG. 18 is a flowchart featuring an exemplary icon-hierarchy application process.

FIG. 19 is a flowchart featuring an exemplary icon-hierarchy establishment process.

FIG. 20 is a flowchart featuring an exemplary icon-hierarchy establishment process.

FIG. 21 is a flowchart featuring an exemplary icon-based communication forwarding process.

FIG. 22A features an exemplary filter-stage user interface.

FIG. 22B features an exemplary communication-creation user interface.

### DETAILED DESCRIPTION

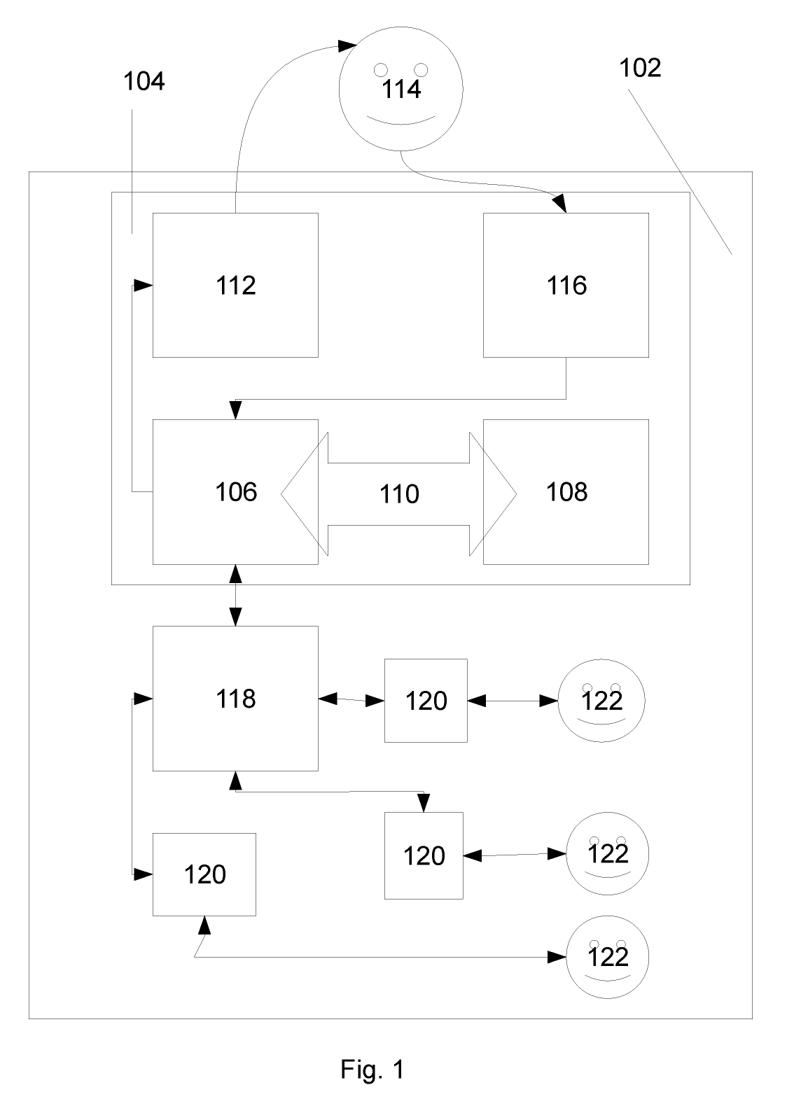

FIG. 1 is a diagram of an exemplary system. As show in FIG. 1, a computer system 102 for performing the embodiments described herein may comprise one or more programmed computers 104. Each programmed computer may comprise a processor 106 engaged with a computer memory 108 to execute instructions 110 loadable onto and then provided by the computer memory. The computer system may also comprise one or more display devices 112 to graphically display to a user 114 the embodiments described herein, and one or more input devices 116 to receive selection, indication, and movement instructions from the user. The computer system may be embodied by a traditional desktop computer, a laptop, or mobile device. In yet another embodiment, the computer system accesses a network 118, which may connect it to one or more other programmed computers 120 and users 122. The network may comprise a set of computing devices connected over the internet. The network may include access via Wi-fi or Bluetooth. In yet another embodiment, computer memory 108 may additionally comprise a database.

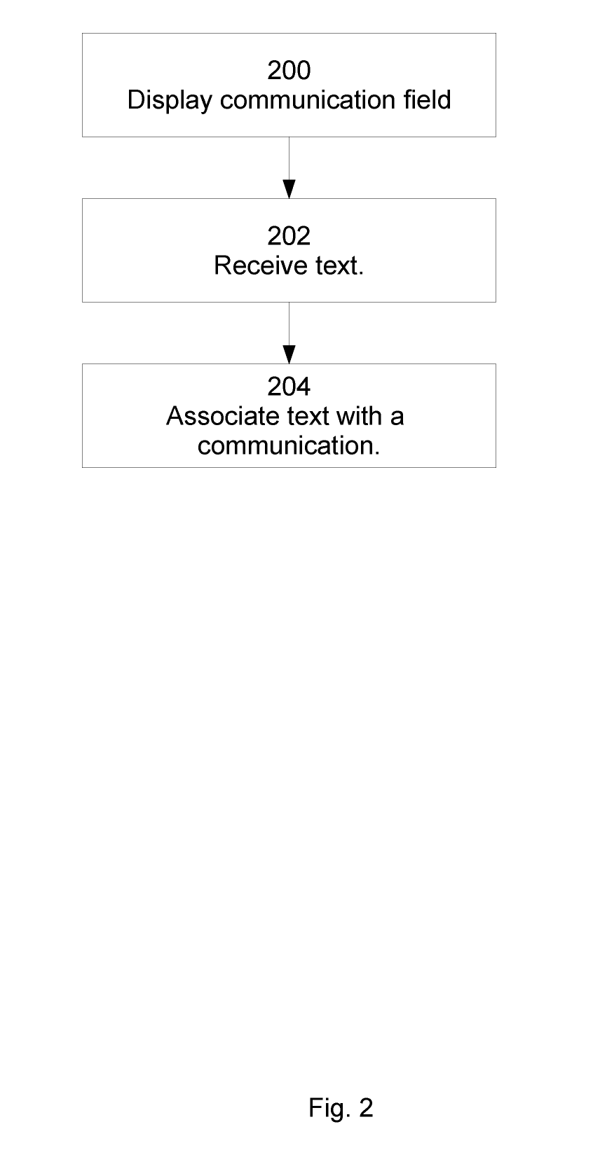

FIG. 2 is a flowchart featuring an exemplary text association process. The system is programmed to: Display communication field 200, receive text 202, associate text with a communication 204. The communication field may be a region of the user interface, possibly bounded, that may be selected by the user for entering text The text may be typed or otherwise entered into the communication field. This text may be intended by the user to form a part or portion of a message communicated to one or more users, and as such, is part of a communication package or unit. Accordingly, the system will associate the text with the communication in a database in which the communication is stored.

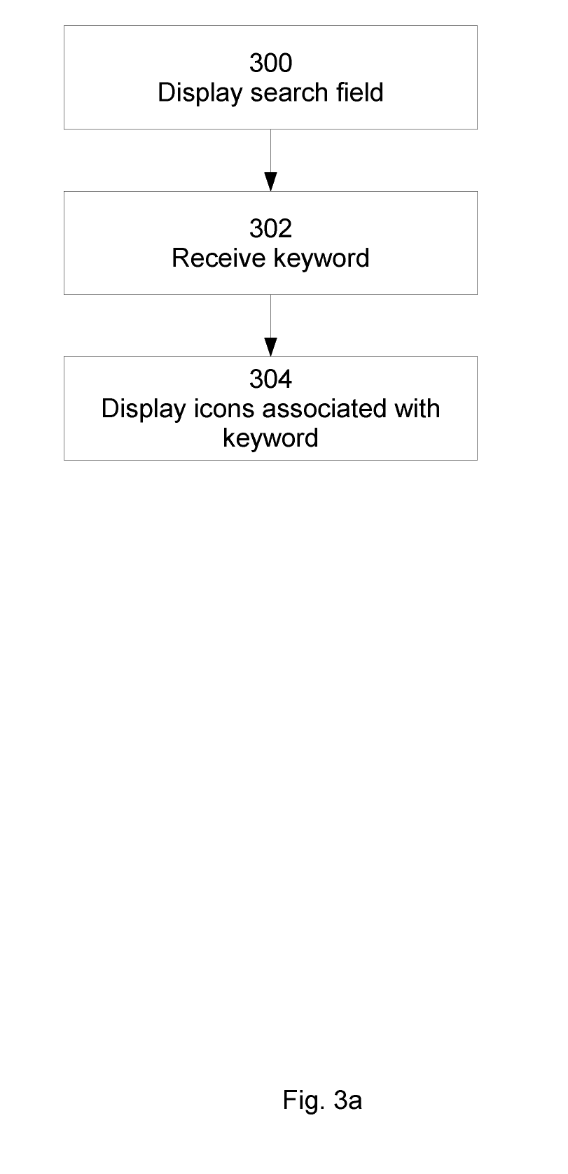

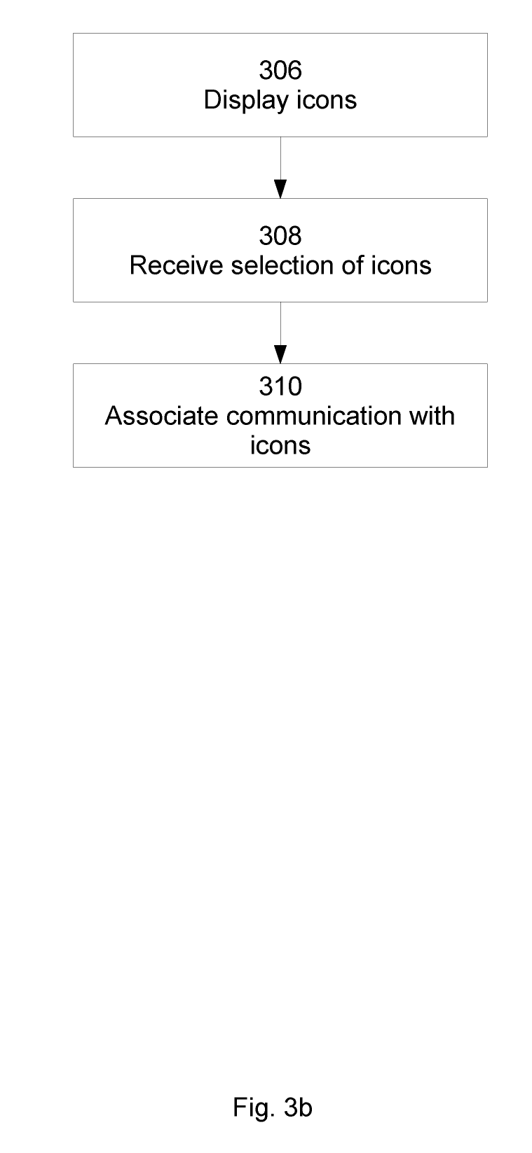

FIG. 3a is a flowchart featuring an exemplary search process. The system is programmed to: Display search field 300, receive keywords 302, display icons associated with keyword 304. The search field may be an area of the user interface, possibly bounded, and configured to receive the input of one or more keywords. The system may scan a database for these keywords, and determine if and what icons are associated with one or more of the keywords. It will then display the icons associated with the keyword or keywords. The search field may be displayed adjacent to or overlapping a graphic representation of the communication above, or may appear in a separate section of the user interface.

FIG. 3b is a flowchart featuring an exemplary icon association process. The system is programmed to: Display icons 306, receive selection of icons 308, associate communication with icons 310. The user may select from the displayed icons a set of one or more icons that the user wishes to add to the communication, and the system may add those selected icons by associating them in a communication database under an icon column. In this sense, the icon acts as metadata. The initially displayed list of icons may be displayed adjacent to or overlapping the graphic representation of the communication above, or may appear in a separate section of the user interface.

Communications may be searched using the icon filtering process. The search may omit searching the text or content of a communication and may instead scan through an exclusively icon category for icon(s) that match the search entry. When the search process determines that a given communication's icon metadata matches the icon entered in the search field or selected from a set of icons, the system may access, send, and/or display the communication associated with that icon.

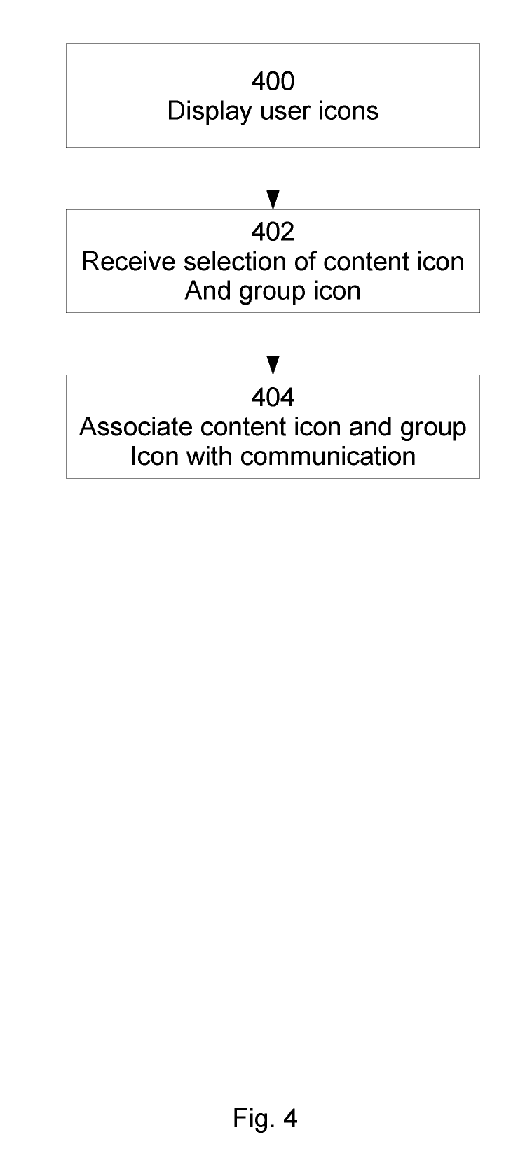

FIG. 4 is a flowchart featuring an exemplary icon association process. The system is programmed to: Display content icons in content area and group icons in group area 400, receive selection of content icon and group icon 402, associate content icon and group icon with communication 404.

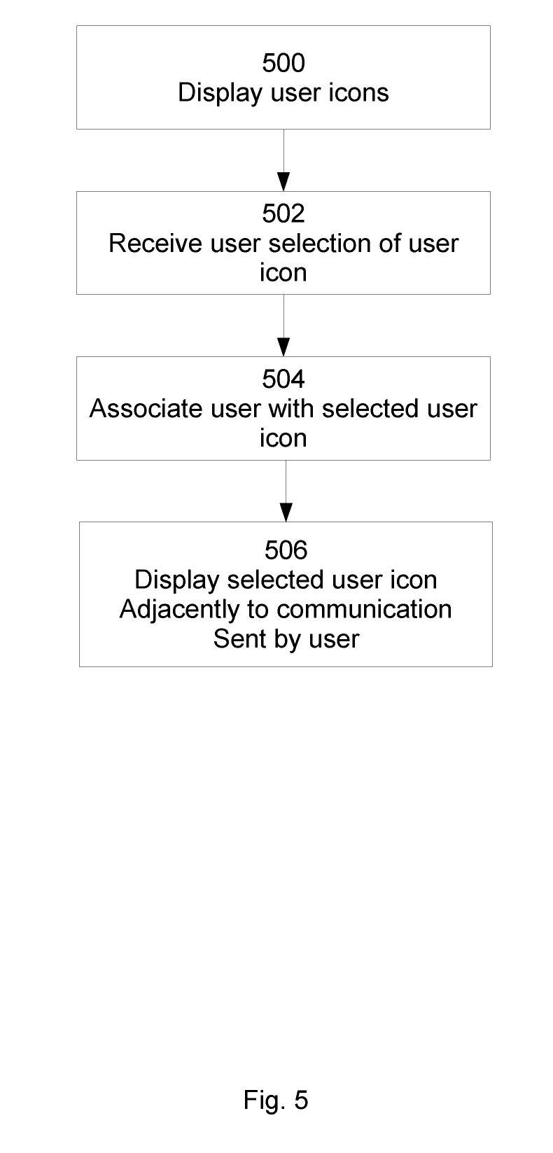

FIG. 5 is a flowchart featuring an exemplary user icon identification process. The system is programmed to: Display user icons 500, receive user selection of user icon 502, associate user with selected user icon 504, display selected user icon adjacent to communications sent by user 506.

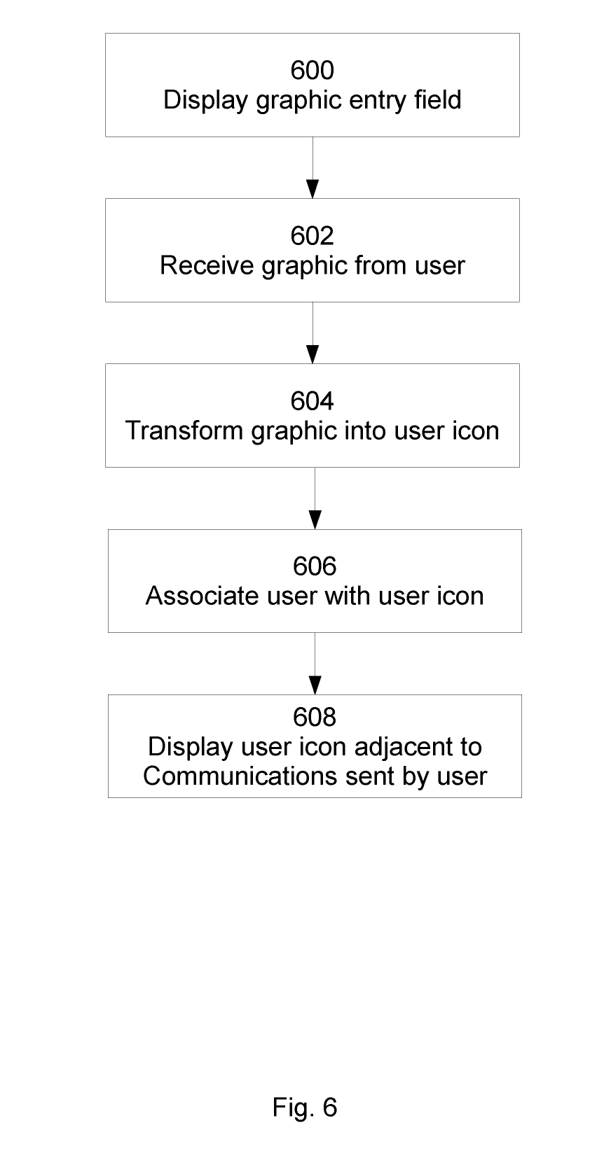

FIG. 6 is a flowchart featuring an exemplary user icon identification process. The system is programmed to: Display graphic entry field 600, receive graphic from user 602, transform graphic into user icon 604, associate user with user icon 606, display user icon adjacent to communications sent by user 608.

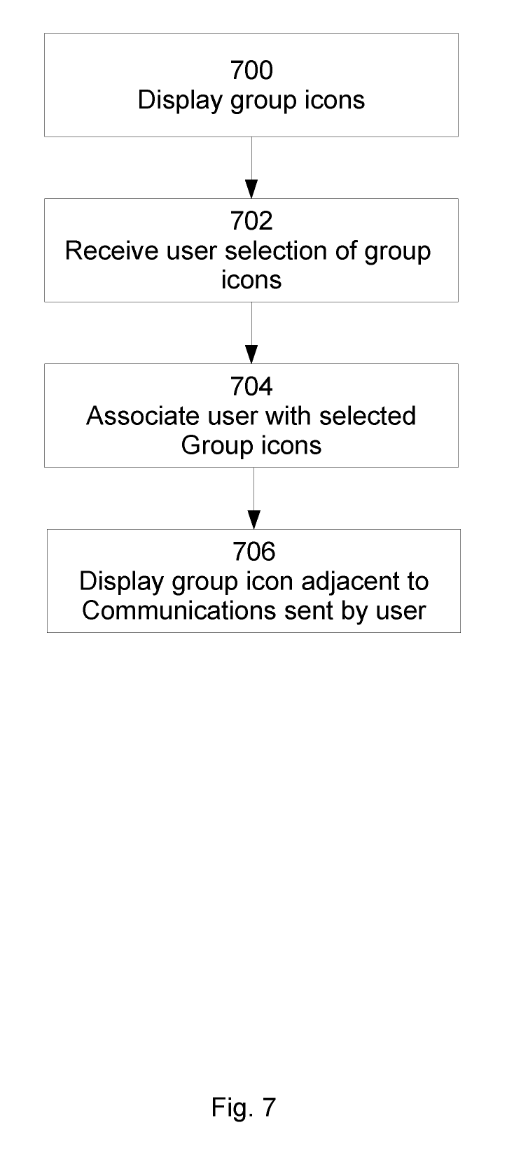

FIG. 7 is a flowchart featuring an exemplary group icon identification process. The system is programmed to: Display group icons 700, receive user selection of group icons 702, associate user with selected group icons 704, display group icon adjacent to communications sent by user 706.

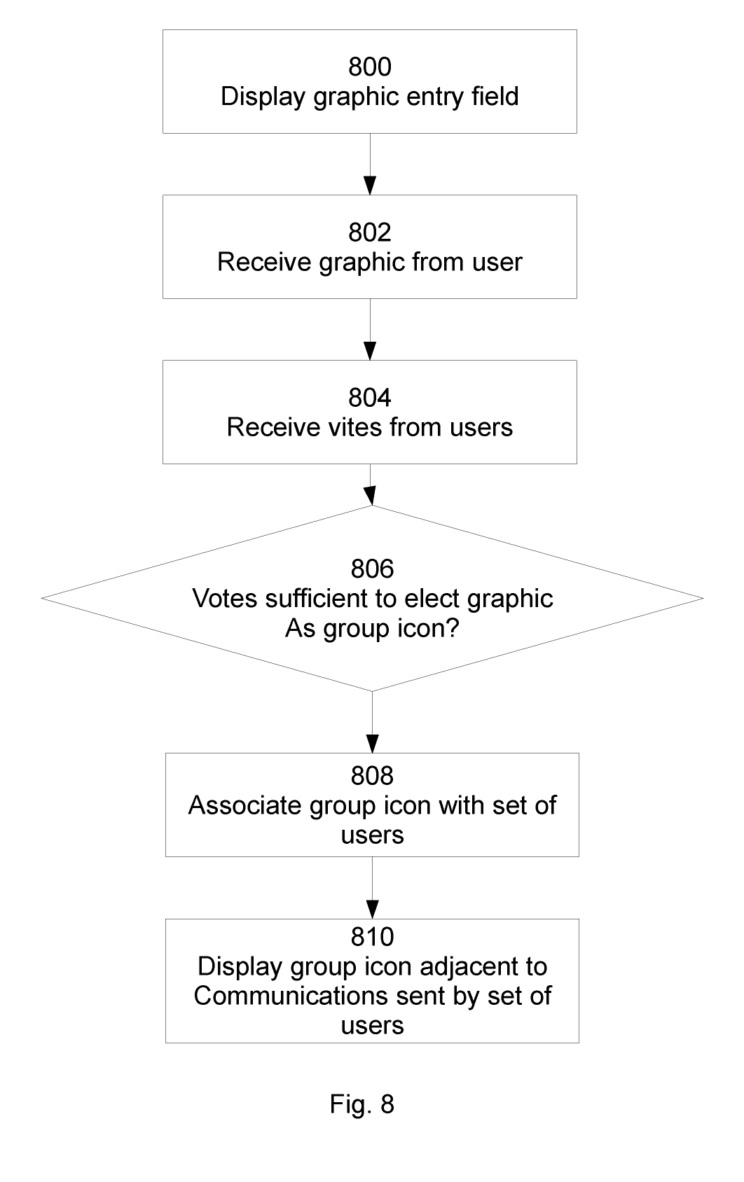

FIG. 8 is a flowchart featuring an exemplary group icon identification process. The system is programmed to: Display graphic entry field 800, receive graphic from user 802, receive votes from users 804, determine if votes are sufficient to elect graphic as group icon 806, and if so, associate group icon with set of users and display group icon adjacent to communications sent by set of users 808.

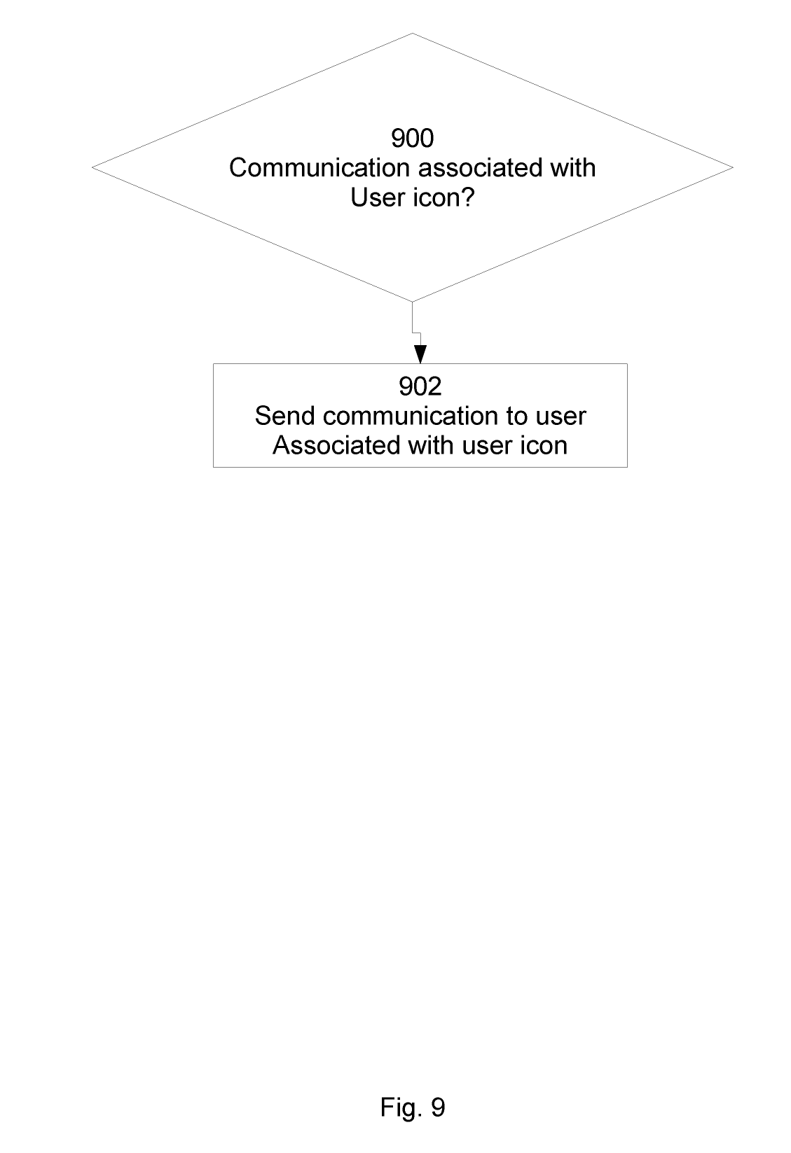

FIG. 9 is a flowchart featuring an exemplary user-user communication process. The system is programmed to: If communication is associated with user icon 900, send communication to user associated with user icon 902.

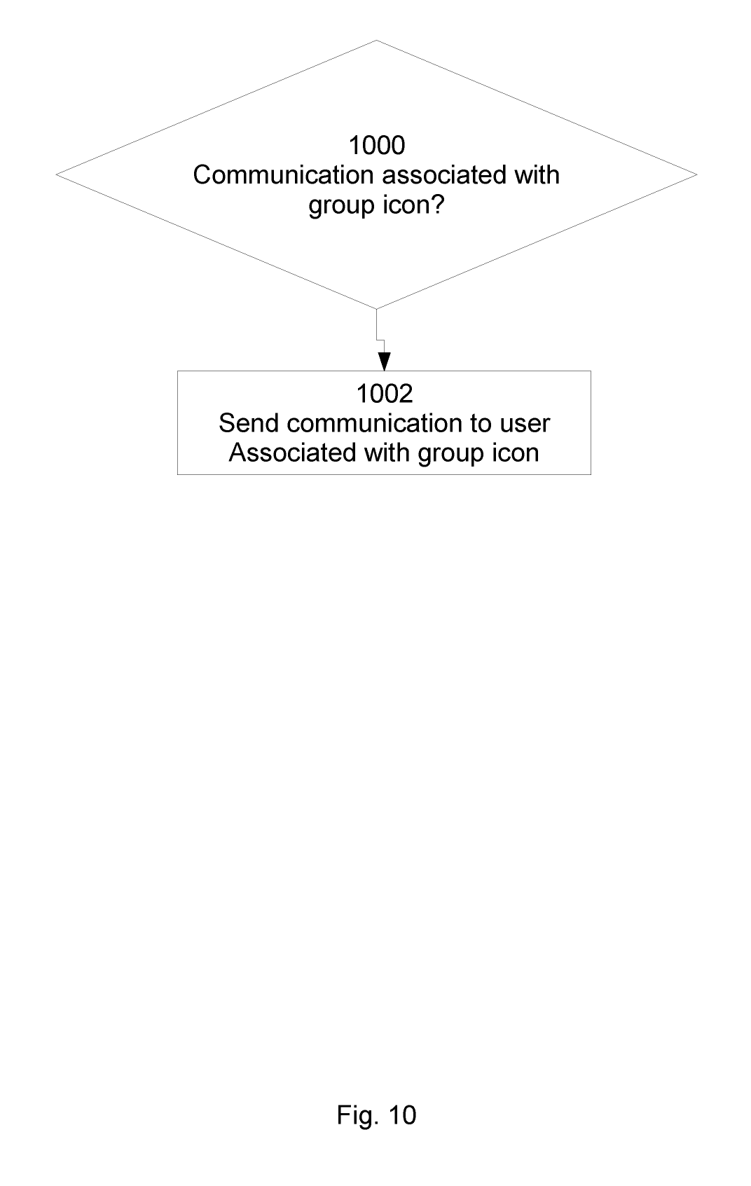

FIG. 10 is a flowchart featuring an exemplary group communication process. The system is programmed to: If communication is associated with group icon 1000, send communication to users associated with group icon 1002.

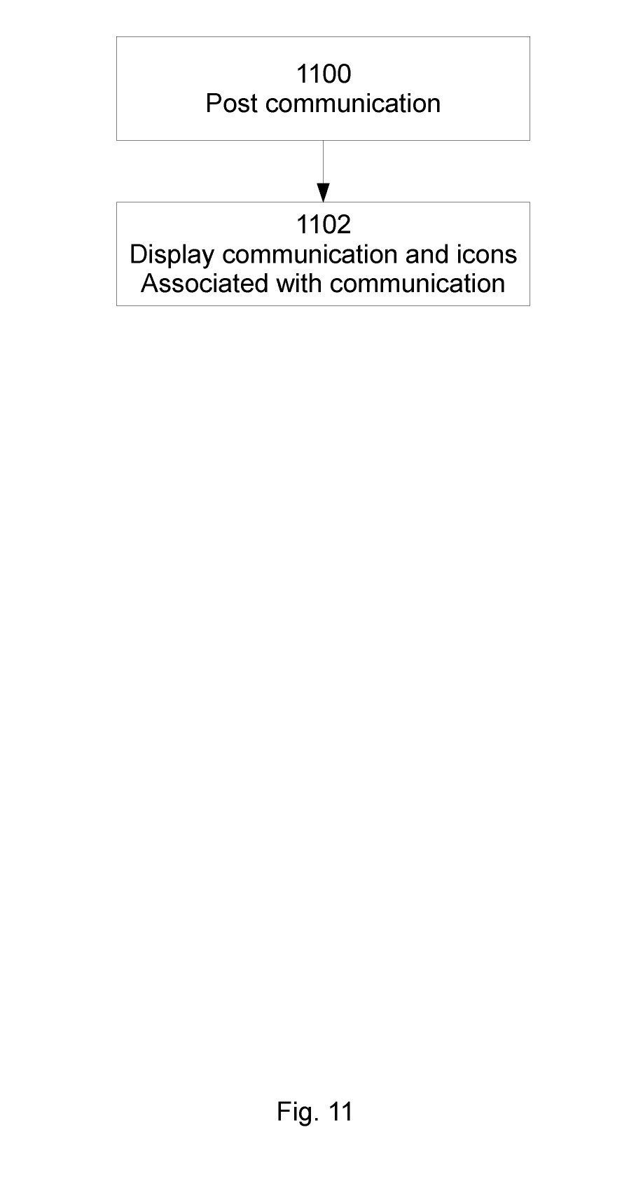

FIG. 11 is a flowchart featuring an exemplary communication process. The system is programmed to: Post communication 1100, display communication and icons associated with communication 1102.

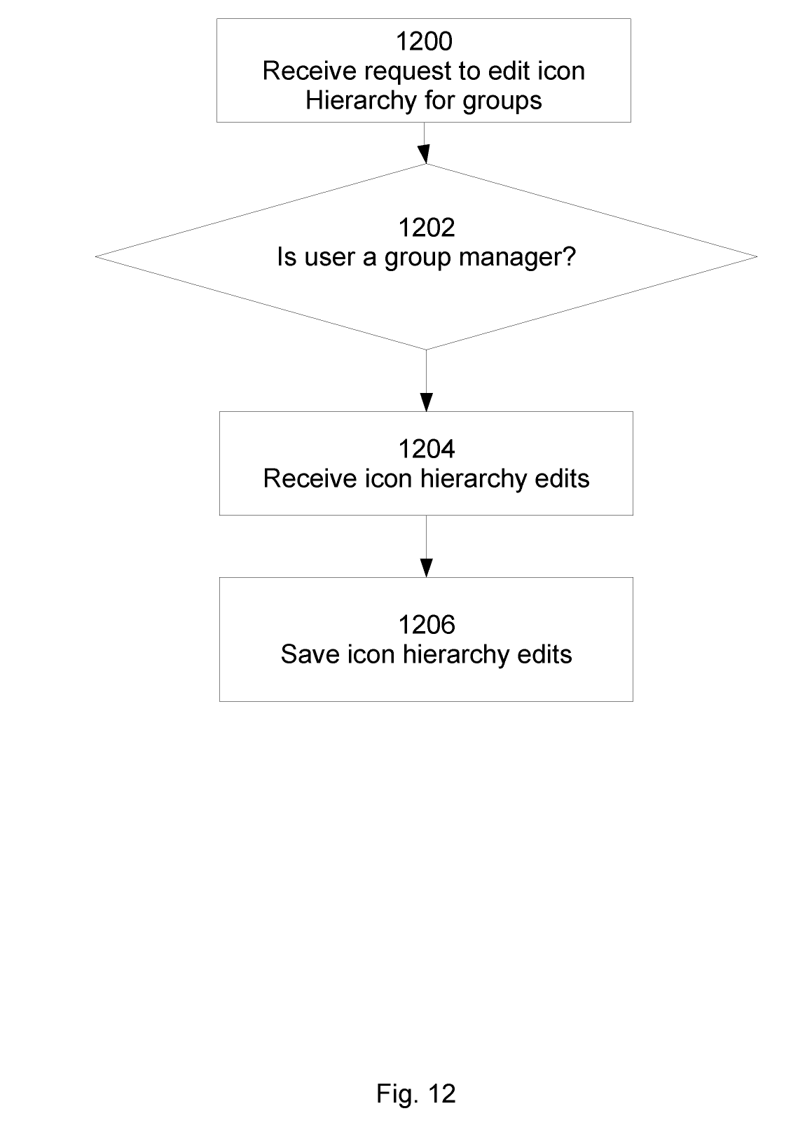

FIG. 12 is a flowchart featuring an exemplary group hierarchy control process. The system is programmed to: Receive request to edit icon hierarchy for group 1200, determine if user is a group manager 1202, receive icon hierarchy edits 1204, save icon hierarchy edits 1206.

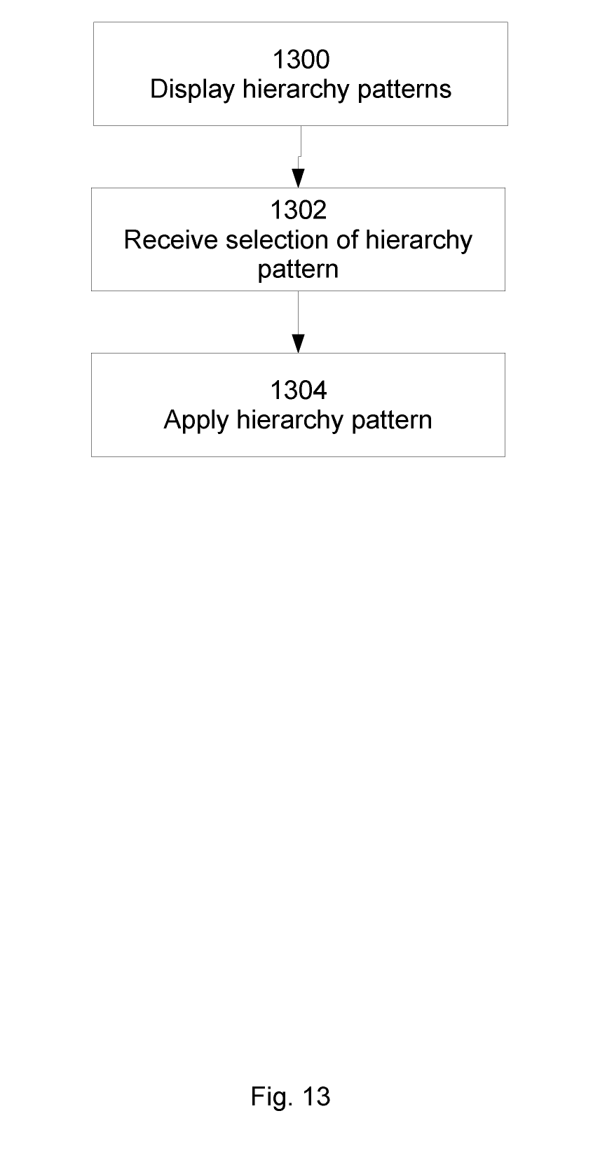

FIG. 13 is a flowchart featuring an exemplary group hierarchy control process. The system is programmed to: Display hierarchy patterns 1300, receive selection of hierarchy pattern 1302, apply hierarchy pattern 1304.

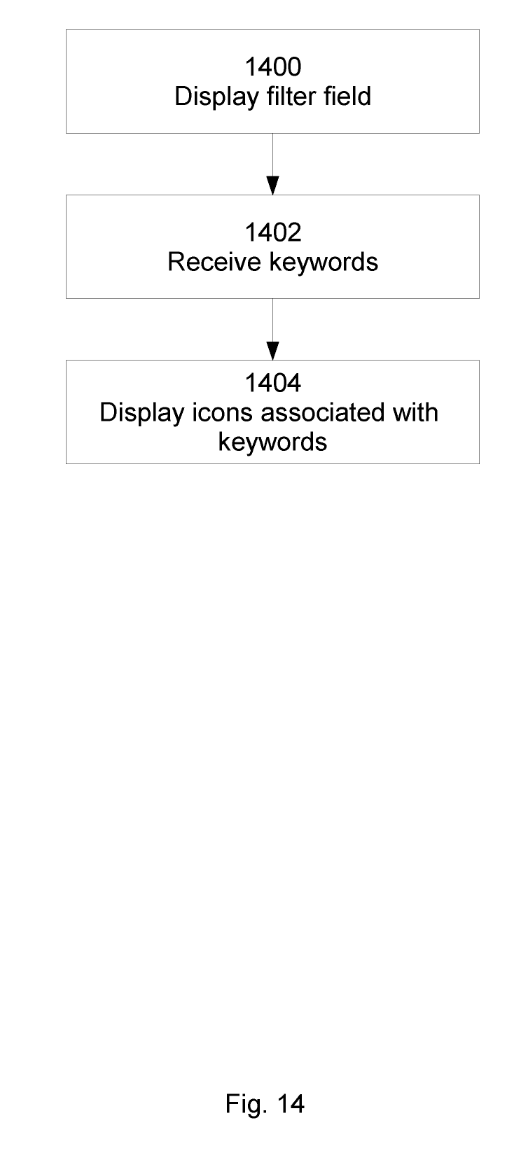

FIG. 14 is a flowchart featuring an exemplary icon filtering process. The system is programmed to: Display filter field 1400, receive keywords 1402, display icons associated with keywords 1404.

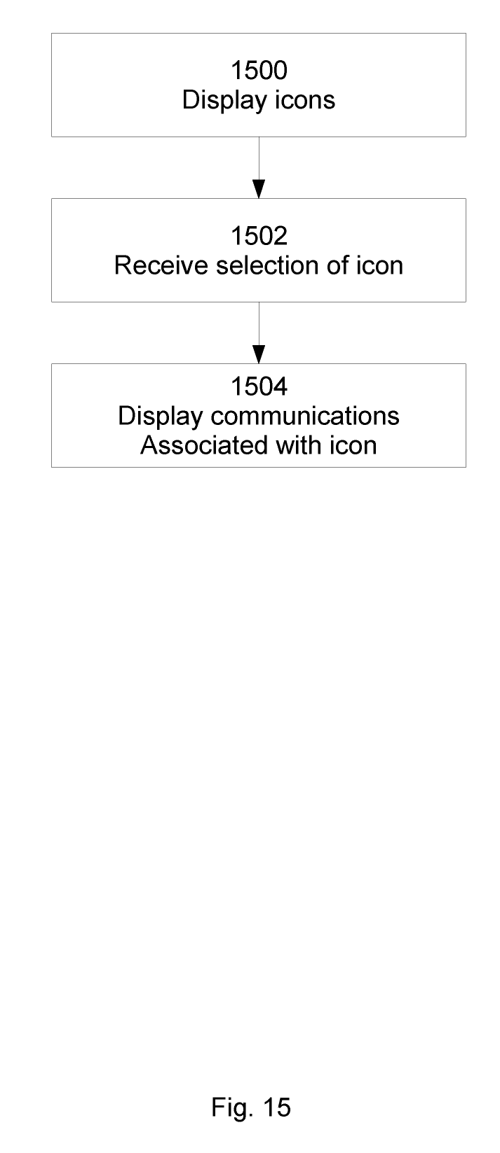

FIG. 15 is a flowchart featuring an exemplary icon-based communication filtering process. The system is programmed to: Display icons 1500, receive selection of icon 1502, display communications associated with icon 1504.

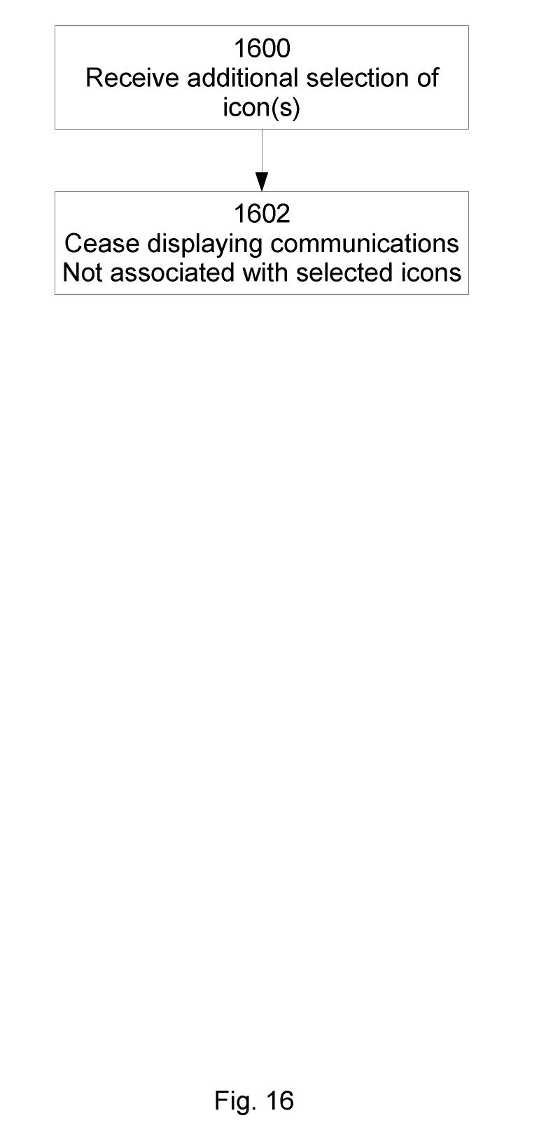

FIG. 16 is a flowchart featuring an exemplary icon-based communication filtering process. The system is programmed to: Receive additional selection of icon(s) 1600, cease displaying communications not associated with selected icons 1602.

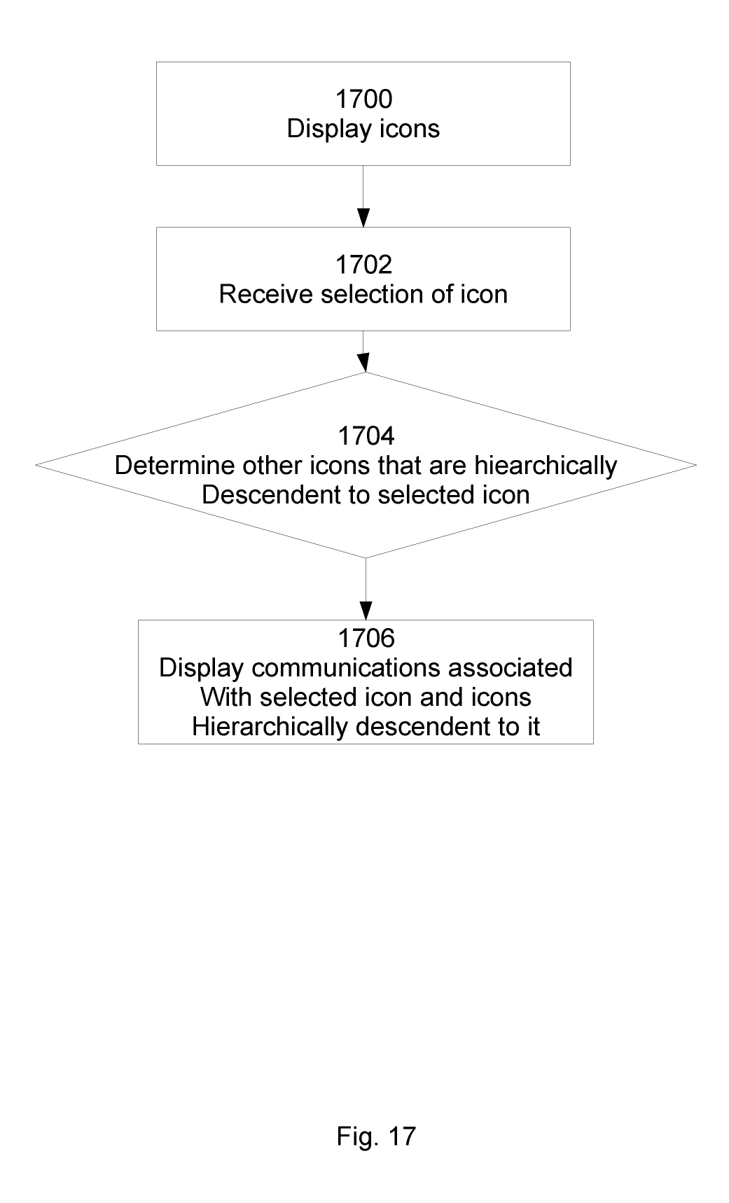

FIG. 17 is a flowchart featuring an exemplary icon hierarchy-based communication filtering process. The system is programmed to: Display icons 1700, receive selection of icon 1702, determine other icons that are hierarchically descendent to selected icon 1704, display communications associated with selected icon and icons hierarchically descendent to it 1706.

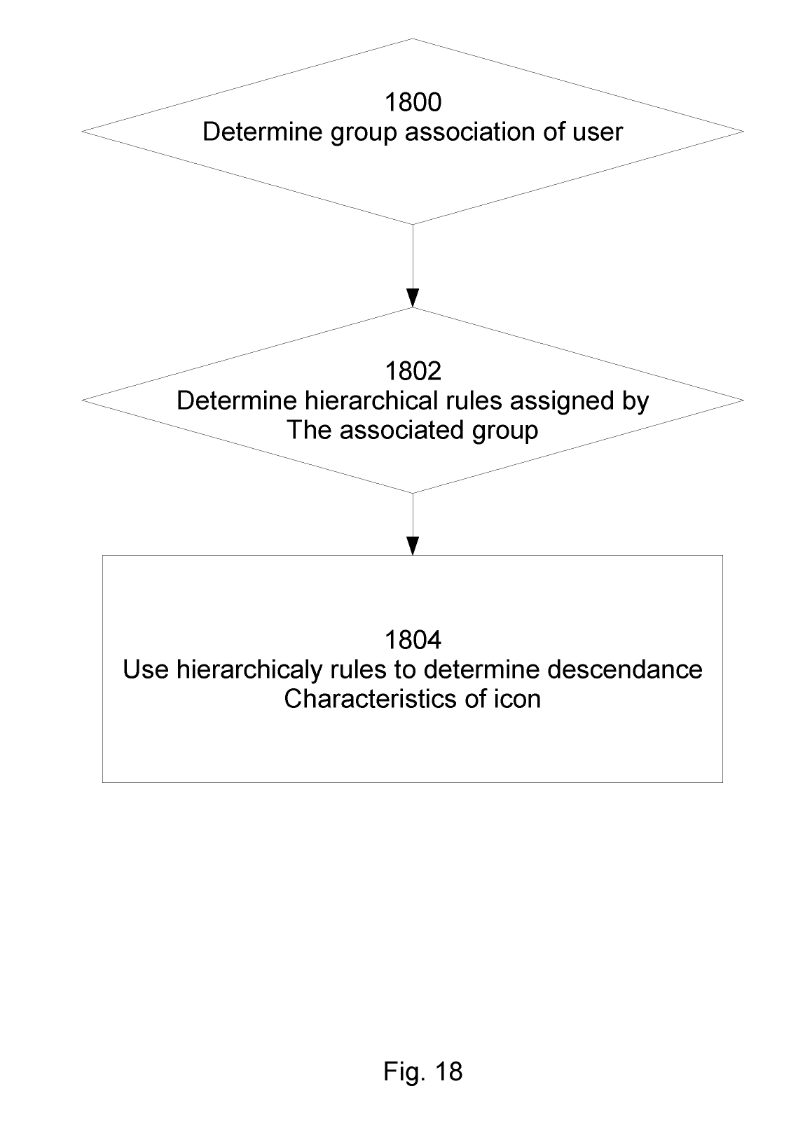

FIG. 18 is a flowchart featuring an exemplary icon-hierarchy application process. The system is programmed to: Determine group association of user 1800, determine hierarchical rules assigned by the associated group 1802, use hierarchical rules to determine descendance characteristics of icon 1804.

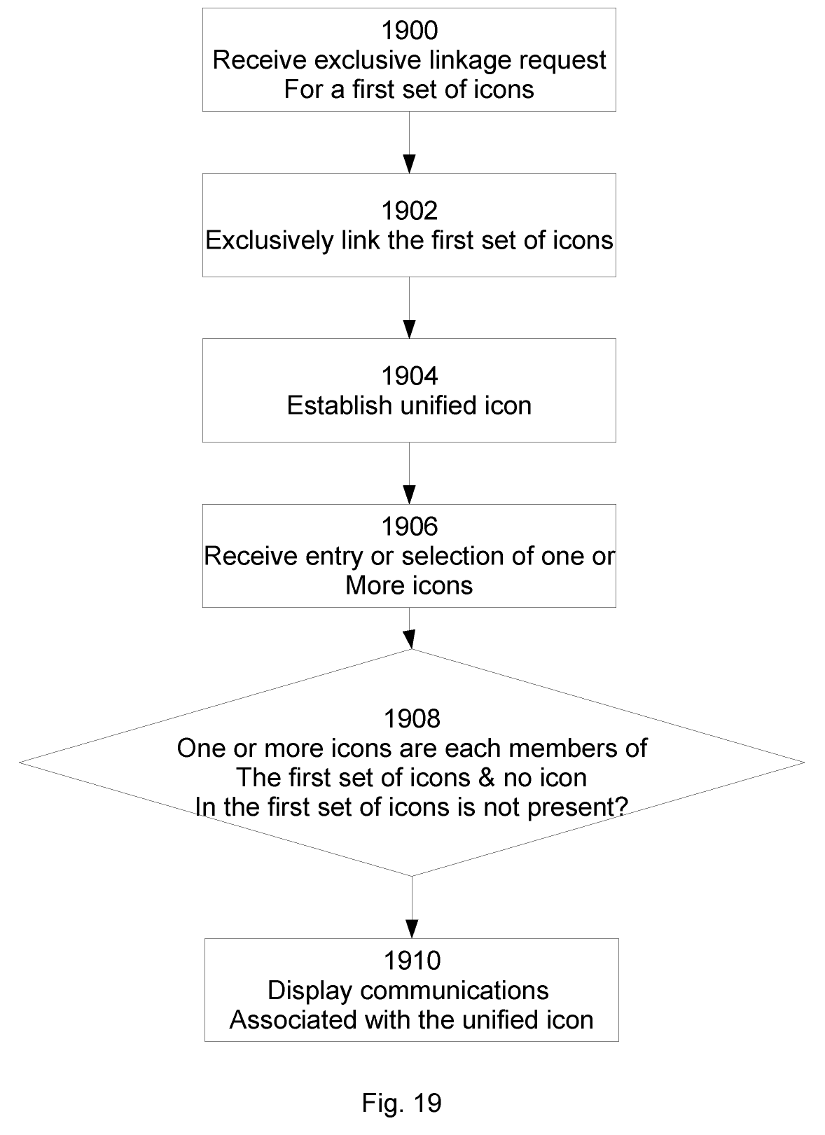

FIG. 19 is a flowchart featuring an exemplary icon-hierarchy establishment process. The system is programmed to: Receive exclusive linkage request for a first set of icons 1900, exclusively link the first set of icons 1902, establish unified icon 1904, receive entry or selection of one or more icons 1906, determine if the one or more icons are each members of the first set of icons and that no icon in the first set of icons is not present the one or more icons 1908, if so, display communications associated with the unified icon 1910.

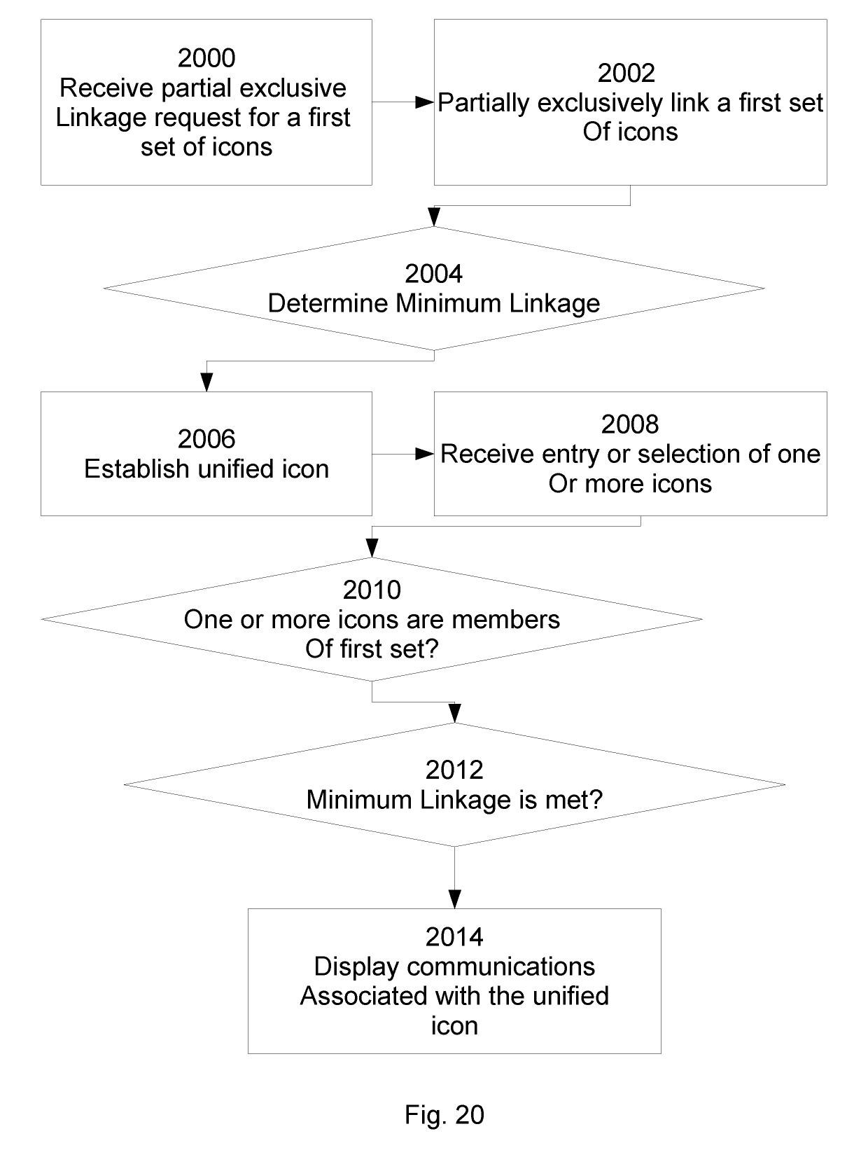

FIG. 20 is a flowchart featuring an exemplary icon-hierarchy establishment process. The system is programmed to: Receive partial exclusive linkage request for a first set of icons 2000, partially exclusively link a first set of icons 2002, determine minimum linkage 2004, establish unified icon 2006, receive entry or selection of one or more icons 2008, determine if the one or more icons are members of the first set of icons 2010, determine if minimum linkage is met 2012, if so, display communications associated with the unified icon 2014.

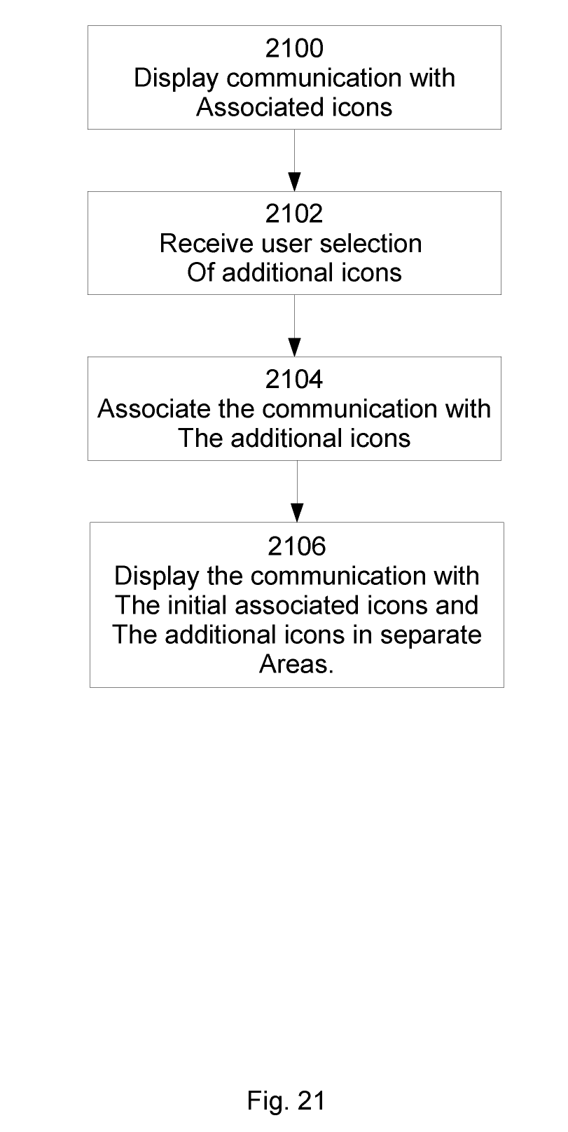

FIG. 21 is a flowchart featuring an exemplary icon-based communication forwarding process. The system is programmed to: Display a communication with associated icons 2100, receive user selection of additional icons 2102, associate the communication with the additional icons 2014 and display the communication with the initial associated icons and the additional icons in separate areas 2016.

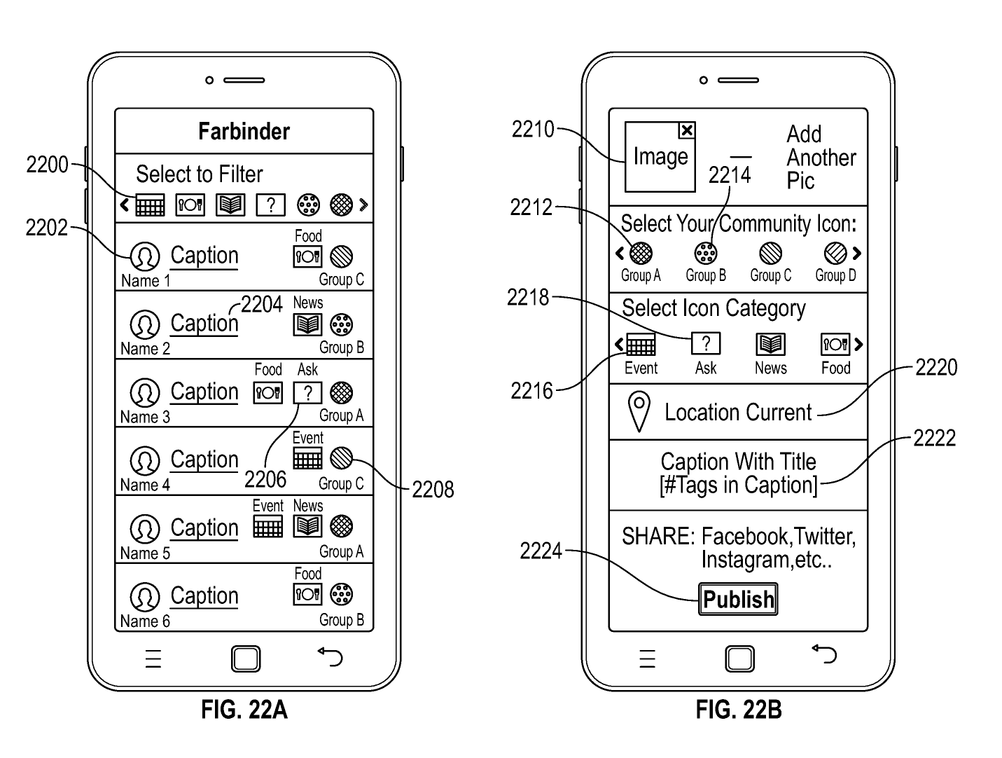

FIG. 22A features an exemplary filter-stage user interface. A portion of the user interface provides for a set of icons 2200 to be displayed—these icons may be selected by the user to indicate what communications he or she wishes to see. Once a set of one or more icons are selected, communications associated with those icons are displayed. Each communication may feature an image, photo, or icon of the sender 2202, a caption or text 2204, a content icon 2206, and a group icon 2208.

FIG. 22B features an exemplary communication creation stage of the user interface. A portion 2222 may provide a field for the entry of text, another 2220 may identify the geographic location of the user, either manually inputted or automatically derived from the device's GPS, a set of icons indicating content category 2218 and which may be selected by the user, a set of icons indicating group affiliation 2212, which may be similarly selected, and a user name and/or image 2210 of the sending user.

1-20. (canceled)

21. A system comprising a first, second, and third processor, the first processor coupled to a first display screen and a first set of input devices and configured to be used by a first user, the second processor coupled to a second display screen and a second set of input devices and configured to be used by a second user, the third processor coupled to a third display screen and a third set of input devices and configured to be used by a third user, the first, second, and third processors connected over a network;
the first processor programmed to receive text communications from a first user via the first set of input devices, requests to tag each text communication with a group icon, and requests to tag each text communication with at least one content icon, with each group icon being associated with a set of users;
the second processor programmed to display a set of group icons on a first region of the second display screen, a set of content icons on a second region of the second display screen, and text communications from the first user on a third region of the second display screen, the set of group icons and the set of content icons each displayed in rows or columns, the text communications featuring user icons, the user icons indicating text communication senders and being distinct from group icons and content icons, with group icons being distinct from content icons;
then receive a selection of a group icon from the second user via the second set of input devices, then display text communications tagged with the selected group icon;
then receive a selection of a first content icon, then continue displaying text communications tagged with the selected group icon but cease displaying text communications not tagged with the first content icon;
wherein tags provide contextual information to text communications and icons can be used in searching.

22. The system in claim 21, the second processor additionally programmed to receive a request from the second user to tag a text communication posted by the first user with a second content icon, then upon receiving a request from the second user to filter communications using the second content icon, display the text communication posted by the first user.

23. The system in claim 21, the first, second, and third processor programmed to equate a first unified icon with a first set of lower rank icons and a second unified icon with a second set of lower rank icons;
the first processor additionally programmed to receive a first and second set of text communications from the first user, a request to tag each text communication of the first set of text communications with the first unified icon, and a request to tag each text communication of the second set of text communications with the second set of lower rank icons and then tag the each text communication of the first set of text communications with the first set of lower rank icons or tag the each text communication of the second set of text communications with the second unified icon;
the second processor additionally programmed to receive from the second user a selection of each of the lower rank icons in the first set of lower rank icons, then display text communications tagged with the first unified icon, receive a selection of the second unified icon, then display text communications tagged with each lower rank icon of the second set of lower rank icons.

24. The system in claim 23, the second processor additionally programmed to receive from the second user a selection of at least a number of icons in the first set of lower rank icons matching a pre-determined ratio for partially exclusive linkage but not all icons in the first set of lower rank icons, then display text communications associated with the first unified icon.

25. The system in claim 23, the second processor additionally programmed to receive from the second user a desired ratio for partially exclusive linkage, then only display the first unified icon if the second user selects at least the desired ratio of icons of the first set of lower rank icons.

26. The system in claim 23, the first processor additionally programmed to tag a text communication with an icon in response to the user conventionally selecting that icon, but if the second user alternatively selects that icon, display lower rank icons that equate to the icon or unified icons of which the icon is equated to, and then, upon receiving a conventional selection of a lower rank icon or unified icon, tag the lower rank icon or unified icon to the text communication.

27. The system in claim 21, the third processor programmed to receive a new content icon from a third user via the third set of input devices, then add the new content icon to an icon database, and then transfer an icon database update to the first and second processor;
the second processor programmed to display the new content icon to the second user adjacent to a text communication field, then receive from the second user a request to tag a new text communication with the new content icon, then tag the new text communication with the new content icon, then transfer the new text communication to the third processor;
the third processor additionally programmed to, upon receiving the new text communication, include the new text communication in a display of text communications filtered by the third user by selecting the new content icon.

28. The system in claim 23, the third processor programmed to: receive from the third user via the third set of input devices a request to equate a third set of lower rank icons to a third unified icon, then add the third unified icon and the relationship between the third unified icon and the third set of lower rank icons to an icon database, and then transfer an icon database update to the first and second processor;
the first processor programmed to display the third unified icon;
then upon receiving a request to tag a new text communication with the third set of lower rank icons, tag the new text communication with the third set of lower rank icons or the third unified icon;
the second processor programmed to receive a request from the second user to filter text communications using the third unified icon, then display text communications tagged with the third set of lower rank icons.

29. A system comprising a first, second, and third processor, the first processor coupled to a first display screen and a first set of input devices and configured to be used by a first user, the second processor coupled to a second display screen and a second set of input devices and configured to be used by a second user, the first, second, and third processors connected over a network;
the first processor programmed to receive text communications from a first user via the first set of input devices, requests to tag each text communication with a group icon, and requests to tag each text communication with at least one content icon, with each group icon being associated with a set of users and each content icon being associated with a subject from a set of subjects;
the first, second, and third processors programmed to equate a first unified icon with a first set of lower rank icons and a second unified icon with a second set of lower rank icons;
the first processor additionally programmed to receive a first and second set of text communications from the first user, a request to tag each text communication of the first set of text communications with the first unified icon, and a request to tag each text communication of the second set of text communications with the second set of lower rank icons;
wherein tags provide contextual information to text communications and icons can be used in searching.

30. The system in claim 29, the first processor additionally programmed to receive from the first user a frame assignment on a first icon, the frame being a graphical modification of an icon from a set including a change in color, shape, hue, saturation, and borders.

31. (canceled)

32. The system in claim 29, the first processor additionally programmed to: upon receiving the request to tag each text communication of the first set of text communications with the first unified icon, tag each text communication of the first set of text communications with the first set of lower rank icons.

33. The system in claim 29, the first processor additionally programmed to: upon receiving the request to tag each text communication of the second set of text communications with the second set of lower rank icons, tag each set of text communications of the second set of text communications with the second unified icon.

34. The system in claim 29, the first processor additionally programmed to tag a text communication with an icon in response to the user conventionally selecting that icon, but if the second user alternatively selects that icon, display lower rank icons that equate to the icon or unified icons of which the icon is equated to, and then, upon receiving a conventional selection of a lower rank icon or unified icon, tag the selected lower rank icon or unified icon to the text communication.

35. The system in claim 29, the third processor programmed to: receive from the third user a request to equate a third set of lower rank icons to a third unified icon, then add the third unified icon and the relationship between the third unified icon and the third set of lower rank icons to an icon database, and then transfer an icon database update to the first and second processor.

36. The system in claim 29, the third processor programmed to receive a new icon from a third user via the third set of input devices, then add the new icon to an icon database, and then transfer an icon database update to the first and second processor;
the second processor programmed to display the new icon to the second user adjacent to a text communication field, then receive from the second user a request to tag a new text communication with the new icon, then tag the new text communication with the new icon, then transfer the new text communication to the third processor;
the third processor additionally programmed to, upon receiving the new text communication, include the new text communication in a display of text communications filtered by the third user by selecting the new icon.

37. A system comprising a first, second, and third processor, the first processor coupled to a first display screen and a first set of input devices and configured to be used by a first user, the second processor coupled to a second display screen and a second set of input devices and configured to be used by a second user, the first, second, and third processors connected over a network;
the second processor programmed to display a set of group icons on a first region of the second display screen, a set of content icons on a second region of the second display screen, and text communications from the first user on a third region of the second display screen, the set of group icons and the set of content icons each displayed in rows or columns, the text communications featuring user icons, the user icons indicating text communication senders and being distinct from group icons and content icons, with group icons being distinct from content icons;
then receive a selection of a content icon, then continue displaying text communications tagged with the selected group icon but cease displaying text communications not tagged with the content icon;
wherein tags provide contextual information to text communications and icons can be used in searching.

38. The system in claim 37, the second processor additionally programmed to receive from the second user a selection of the unified icon, then display text communications tagged with the unified icon or each lower rank icon of a set of lower rank icons equated with the unified icon.

39. The system in claim 38, the second processor additionally programmed to receive from the second user a selection of at least a number of icons in the set of lower rank icons matching a pre-determined ratio for partially exclusive linkage but not all icons in the set of lower rank icons, then display text communications associated with the unified icon.

40. The system in claim 38, the second processor programmed to: receive from the second user a request to equate a second set of lower rank icons to a second unified icon, then add the second unified icon and the relationship between the second unified icon and the second set of lower rank icons to an icon database, then transfer an icon database update to the first and third processor;
the third processor programmed to, upon receiving a request from the third user to filter text communications using the second unified icon, display text communications tagged with the second set of lower rank icons.
